(19) United States
(12) Patent Application Publication
(10) Pub. No.: US 2008/0282009 A1
(43) Pub. Date: Nov. 13, 2008

(54) DRIVING DEVICE FOR EXPANSION CARD AND DRIVING METHOD THEREOF AND MOTHERBOARD

(75) Inventors: Yuan-Te Fu, Taipei (TW); Te-Chuan Kuo, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/117,742

(22) Filed: May 9, 2008

(30) Foreign Application Priority Data
May 11, 2007 (TW) 96116829

(51) Int. Cl. G06F 13/00

(52) U.S. Cl. 710/301

(57) ABSTRACT

A driving device for an expansion card, a driving method thereof and a motherboard are provided. The driving method includes the step of detecting the information of an expansion card. When the information indicates that the expansion card is a nonstandard interface expansion card, a switch is turned on, and a chip unit drives the nonstandard interface expansion card via the switch. When the information indicates that the expansion card is a standard interface expansion card, the switch is turned off, and the chip unit drives the standard interface expansion card.

### CROSS-REFERENCE TO RELATED APPLICATION

This application claims the priority benefit of Taiwan application serial no. 96116829, filed on May 11, 2007. The entirety of the above-mentioned patent application is hereby incorporated by reference herein and made a part of specification.

### BACKGROUND OF THE INVENTION

1. Field of the Invention

The invention relates to a driving technology for an expansion card and, more particularly, to a driving device for an expansion card, a driving method thereof and a motherboard.

2. Description of the Related Art

Along with the progress of the computer technology, the expansibility of a motherboard is gradually valued. Generally speaking, along with the increase of the number of slots on the motherboard, the expansibility of the motherboard becomes better. To enable the motherboard to correctly drive expansion cards with different standard interfaces, in the conventional technology, fool-proof structures of the slots are usually utilized to enable a user easily to install the expansion cards with different standard interfaces to the corresponding slots, so that the misplacement problem cannot occur.

For example, a high definition (HD) audio (HD audio for short) card only can be installed to a high definition link (HD link for short) slot of the motherboard. In other words, a HD link slot needs to be projected at the motherboard for the HD audio card. When the user does not use the HD audio card, the HD link slot is in an idle state and cannot be used by expansion cards with other standard interfaces. For example, the HD link slot cannot be used by an expansion card with a peripheral component interconnect (PCI) interface.

### BRIEF SUMMARY OF THE INVENTION

The invention provides a motherboard, thereby saving the area of the motherboard.

The invention provides a driving device for an expansion card, thereby reducing the cost.

The invention provides a driving method for an expansion card, and expansion cards are driven in different modes according to their standard interfaces, so that a standard interface expansion card or a nonstandard interface expansion card can be driven.

The invention provides a motherboard which includes an interface device, a switch and a chip unit. The interface device is disposed on the motherboard for installing an expansion card and outputting a voltage signal having the information of the expansion card. The switch is coupled to the interface device and operates based on the voltage signal. The chip unit is coupled to the switch and the interface device and is used for driving the expansion card. When the expansion card is a nonstandard interface expansion card, the level of the voltage signal is a first level to make the switch turned on and make the chip unit drive the nonstandard interface expansion card via the switch. When the expansion card is a standard interface expansion card, the level of the voltage signal is a second level to make the switch turned off and make the chip unit drive the standard interface expansion card.

In one embodiment of the invention, the standard interface expansion card is an IEEE 1394 expansion card, a USB expansion card, a SATA expansion card, a network card or a graphic card. In another embodiment, the nonstandard interface expansion card is a high definition (HD) audio card. In another embodiment, the interface device is a PCI interface device coupled to the switch and the chip unit. In another embodiment, the switch is a transistor switch whose first and second terminals are coupled to the interface device and the chip unit, respectively, and the gate electrode terminal of the transistor switch receives the voltage signal. In another embodiment, the chip unit is a south bridge chip coupled to the interface unit and the switch.

The invention further provides a driving device for an expansion card, and the driving device for an expansion card is applied to a motherboard which has a chip unit. The driving device for an expansion card includes an interface device and a switch. The interface device is provided on the motherboard and is coupled to the chip unit. The interface device is used for installing an expansion card and outputs a voltage signal having the information of the expansion card. The switch is coupled between the interface device and the chip unit and determines to be on or off according to the voltage signal. When the expansion card is a nonstandard interface expansion card, the level of the voltage signal is a first level to make the chip unit output a first driving signal via the switch to drive the nonstandard interface expansion card. When the expansion card is a standard interface expansion card, the level of the voltage signal is a second level to make the chip unit output a second driving signal to drive the standard interface expansion card.

The invention further provides a driving method for an expansion card which can be installed on an interface device of a motherboard, and the motherboard has a chip unit and a switch. The driving method for an expansion card includes the step of detecting the information of the expansion card. When the detected information indicates that the expansion card is a nonstandard interface expansion card, the switch is turned on and the chip unit drives the nonstandard interface expansion card via the switch. When the detected information indicates that the expansion card is a standard interface expansion card, the switch is turned off and the chip unit drives the standard interface expansion card.

In one embodiment of the invention, the information of the expansion card is a voltage signal, and when the expansion card is a nonstandard interface expansion card, the level of the voltage signal is a first level. In addition, when the expansion card is a standard interface expansion card, the level of the voltage signal is a second level. In another embodiment, the step of detecting the information of the expansion card includes the step of inserting the expansion card to the interface device to generate the voltage signal. Next, the level of the voltage signal is detected via the switch.

In the invention, by detecting the information of expansion cards, the expansion cards are driven in different modes according to their information. Therefore, many kinds of expansion cards can be driven.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a structural diagram showing a motherboard according to the first embodiment of the invention.

FIG. 2 is a flow chart showing a driving method for an expansion card according to the first embodiment of the invention.

### DETAILED DESCRIPTION OF THE EMBODIMENTS

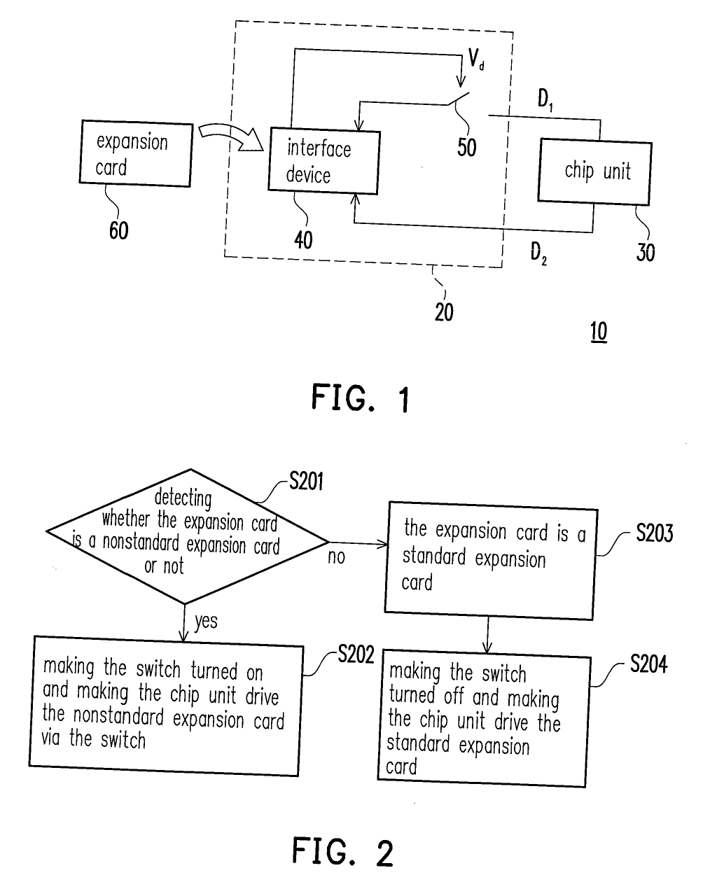

FIG. 1 is a structural diagram showing a motherboard according to the first embodiment of the invention. Please refer to FIG. 1, the embodiment provides a motherboard 10 which includes a driving device 20 for an expansion card and a chip unit 30. The driving device 20 is used for installing an expansion card 60 and is coupled to the chip unit 30. In this way, the chip unit 30 can drive the expansion card 60 via the driving device 20.

The driving device 20 includes an interface device 40 and a switch 50. In the embodiment, the interface device 40 is disposed on the motherboard 10 and is coupled to the chip unit 30 via the switch 50. In the embodiment, the chip unit 30 is a south bridge chip. In another embodiment, the chip unit 30 can also be a controller for managing the driving device 20.

The interface device 40 can be a slot with a PCI interface, but it is not limited in the invention. In other embodiments, the interface device can also be an accelerated graphics port (AGP for short). The interface device 40 allows an expansion card 60 with a standard or nonstandard interface to be inserted in it, and the expansion card 60 with a standard or nonstandard interface can be correctly driven when it is driven in a different driving mode. When an expansion card 60 is installed to the interface device 40, the interface device 40 can output a voltage signal V_{d} having the information of the expansion card 60 from a pin to the switch 50. In this way, the switch 50 can determine to be on or off according to the voltage signal V_{d}. Namely, the switch 50 operates based on the voltage signal V_{d}.

In the embodiment, the switch 50 is a transistor switch such as a transistor switch whose model is HC74244. When the switch 50 is a transistor switch, the first and second terminals of the transistor switch can be coupled to the interface device 40 and the chip unit 30, respectively, and the gate electrode terminal of the transistor switch receives the voltage signal. In this way, the switch 50 can determine to be on or off according to the voltage signal V_{d}. For example, when the level of the voltage signal V_{d} is a high level, the switch 50 is turned on; on the contrary, when the level of the voltage signal V_{d} is a low level, the switch 50 is turned off. The chip unit 30 is coupled to the switch 50 and the interface device 40 to drive the expansion card 60. In the above embodiment, although the switch 50 is a transistor switch, in another embodiment, the switch 50 can also be replaced with any kinds of switches, and it is not limited.

Generally speaking, the expansion cards 60 are classified into two types, that is, the standard interface expansion card and the nonstandard interface expansion card. In a broad sense, the standard interface is an expansion card whose standard interface corresponds to the interface device 40. The nonstandard interface expansion card is an expansion card whose standard interface does not correspond to the interface device 40, but the nonstandard interface expansion card can be inserted to the interface device 40. Specifically, in the embodiment, the standard interface expansion card generally refers to an expansion card with a PCI standard interface, such as an IEEE 1394 expansion card, a USB expansion card, a SATA expansion card, a network card or a graphic card, etc.

In the embodiment, the nonstandard interface expansion card generally refers to an expansion card whose interface does not correspond to the PCI standard interface and still can be inserted to the slot with a PCI interface. The nonstandard interface expansion card can be, for example, a high definition (HD) audio card. Persons having ordinary skill in the art should know that the driving mode of the nonstandard interface expansion card is different from the driving mode of the standard interface expansion card. That is, the driving mode of the standard interface expansion card cannot be used to drive the nonstandard interface expansion card. Similarly, the driving mode of the nonstandard interface expansion card cannot used to drive the standard interface expansion card. To make the driving mode of the expansion card 60 further clearly understood, the driving method for the nonstandard or standard expansion card is illustrated in further details hereinblow.

FIG. 2 is a flow chart showing a driving method for an expansion card according to the first embodiment of the invention. Please refer to FIG. 1 and FIG. 2, simultaneously. When the expansion card 60 is installed to the interface device 40, one pin of the interface device 40 outputs the voltage signal V_{d}, thereby detecting whether the expansion card is a nonstandard interface expansion card or not (step S20 1). When the expansion card 60 is a nonstandard interface expansion card, the interface device 40 can output the voltage signal V_{d} whose voltage level is a high level to the switch 50 to make the switch 50 turned on, and the chip unit 30 can outputs a driving signal D1 for the nonstandard interface expansion card to the interface device 40 via the switch 50 (step S202), thereby driving the nonstandard interface expansion card 60.

On the other hand, in the step S201, when the switch 50 receives the voltage signal V_{d} whose voltage level is a low level, it denotes that the expansion card 60 is a standard interface expansion card (step S203). At this time, the switch 50 is turned off, and therefore, the chip unit 30 cannot output the driving signal D₁ for the nonstandard interface expansion card to the interface device 40 via the switch 50. The chip unit 30 can output a driving signal D₂ for the standard interface expansion card to the interface device 40 via another path, thereby driving the standard interface expansion card 60.

In the embodiment, the switch 50 is switched according to the information of the expansion card, and therefore, different driving signals can be selectively inputted. In other words, an expansion card 60 with a standard or nonstandard interface can be applied to the same interface device 40, so that the expansibility of the motherboard 10 is greatly increased. From another point of view, the interface device 40 is applied to the standard or nonstandard interface expansion card 60, and the specific interface device 40 does not need to be projected at the motherboard 10 for a specific standard interface, so that not only the area of the motherboard is saved, but also the cost is greatly reduced.

Although a possible mode of the driving method for an expansion card is described in the above embodiment, persons having ordinary skill in the art should know that every manufacturer designs different steps for driving an expansion card, and therefore, the scope of the invention is not limited by the possible mode. In other words, as long as the driving method for an expansion card makes expansion cards driven in different modes according to the information of the expansion cards, it is within the scope of the invention.

To sum up, in the invention, by detecting the information of expansion cards, the expansion cards can be driven in different modes according to the information of the expansion cards. Therefore, a standard or nonstandard interface expansion card can be driven. In addition, in the embodiment of the invention, the standard or nonstandard interface expansion card is driven by shifting a switch, which not only can increase the expansibility of the motherboard but also can save the area of the motherboard and reduce the cost.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A motherboard, comprising:
an interface device disposed on the motherboard for installing an expansion card and outputting a voltage signal having the information of the expansion card;
a switch coupled to the interface device and operating based on the voltage signal; and
a chip unit coupled to the switch and the interface device for driving the expansion card,
wherein when the expansion card is a nonstandard interface expansion card, the level of the voltage signal is a first level to make the switch turned on and make the chip unit drive the nonstandard interface expansion card via the switch, and when the expansion card is a standard interface expansion card, the level of the voltage signal is a second level to make the switch turned off and make the chip unit drive the standard interface expansion card.

2. The motherboard according to claim 1, wherein the standard interface expansion card is an IEEE 1394 expansion card, a USB expansion card, a SATA expansion card, a network card or a graphic card.

3. The motherboard according to claim 1, wherein the nonstandard interface expansion card is a high definition (HD) audio card.

4. The motherboard according to claim 1, wherein the interface device is a PCI interface device coupled to the switch and the chip unit.

5. The motherboard according to claim 1, wherein the switch is a transistor switch whose first and second terminals are coupled to the interface device and the chip unit, respectively, and the gate electrode terminal of the transistor switch receives the voltage signal.

6. The motherboard according to claim 1, wherein the chip unit is a south bridge chip coupled to the interface unit and the switch.

7. A driving device for an expansion card, disposed on a motherboard having a chip unit, the driving device comprising:
an interface device disposed on the motherboard and coupled to the chip unit for installing the expansion card and outputting a voltage signal having the information of the expansion card; and
a switch coupled between the interface device and the chip unit and operating based on the voltage signal,
wherein when the expansion card is a nonstandard interface expansion card, the level of the voltage signal is a first level to make the chip unit output a first driving signal via the switch to drive the nonstandard interface expansion card, and when the expansion card is a standard interface expansion card, the level of the voltage signal is a second level to make the chip unit output a second driving signal to drive the standard interface expansion card.

8. The driving device according to claim 7, wherein the standard interface expansion card is an IEEE 1394 expansion card, a USB expansion card, a SATA expansion card, a network card or a graphic card.

9. The driving device according to claim 7, wherein the nonstandard interface expansion card is a high definition (HD) audio card.

10. The driving device according to claim 7, wherein the interface device is a PCI interface device coupled to the switch and the chip unit.

11. The driving device according to claim 7, wherein the switch is a transistor switch whose first and second terminals are coupled to the interface device and the chip unit, respectively, and the gate electrode terminal of the transistor switch receives the voltage signal.

12. The driving device according to claim 7, wherein the chip unit is a south bridge chip coupled to the interface unit and the switch.

13. A driving method for an expansion card which can be installed on an interface device of a motherboard having a chip unit and a switch, the driving method comprising the steps of:
detecting the information of the expansion card;
turning on the switch and using the chip unit to drive the expansion card via the switch, when the information indicates that the expansion card is a nonstandard interface expansion card; and turning off the switch and using the chip unit to drive the expansion card, when the information indicates that the expansion card is a standard interface expansion card.

14. The driving method according to claim 13, wherein the information of the expansion card is a voltage signal, and when the expansion card is the nonstandard interface expansion card, the level of the voltage signal is a first level, and when the expansion card is the standard interface expansion card, the level of the voltage signal is a second level.

15. The driving method according to claim 14, wherein the step of detecting the information of the expansion card comprises the steps of:
inserting the expansion card to the interface device to generate the voltage signal; and
detecting the level of the voltage signal via the switch.
